(19) United States
(12) Patent Application Publication
(10) Pub. No.: US 2026/0320716 A1
(43) Pub. Date: Oct. 15, 2026

(54) RECEIPTIZED OWNERSHIP ALLOCATION USING UNIVERSAL RECEIPT LEDGER AND DETERMINISTIC REPLAY

(71) Applicant: Thomas Hecht, Cambridge, MA (US)

(72) Inventor: Thomas Hecht, Cambridge, MA (US)

(21) Appl. No.: 19/458,981

(22) Filed: Jan. 26, 2026

Related U.S. Application Data
(63) Continuation-in-part of application No. 19/051,264, filed on Feb. 12, 2025, now Pat. No. 12,561,745.
Application No. 19/051,264 is a continuation-in-part of application No. 18/216,329, filed on Jun. 29, 2023, now abandoned.

(51) Int. Cl. G06Q 50/18; G06N 3/044; G06N 3/0495; G06N 3/09

(52) U.S. Cl. CPC G06Q 50/184; G06N 3/044; G06N 3/0495; G06N 3/09

(57) ABSTRACT

A system performs receiptized allocation of ownership of an asset to improve collective economic benefit while preserving continuity of use. The system ingests utilization data and policy context, executes an AI/ML categorization engine to identify an efficient use and a specialized ownership entity, and encodes a transaction that transfers legal title to the entity while preserving usage rights. Each evaluation, selection, and execution step generates typed digital receipts appended to an append-only universal receipt ledger. The ledger supports idempotency, cryptographic commitments, checkpointing, and replay manifests to enable deterministic replay and stateless verification of allocation decisions and entitlement changes. Privacy controls include selective disclosure, controlled redaction, key rotation, and auditable access receipts. The system supports obligation netting and settlement manifests for transaction compression and multi-rail settlement, and records policy rulepack identifiers to govern allocation and sharing of surplus value.

### CROSS-REFERENCE TO RELATED APPLICATIONS

This application is a continuation-in-part of U.S. patent application Ser. No. 19/051,264, filed Feb. 12, 2025, entitled “Artificial Intelligence Systems and Methods for Efficient Use of Assets,” published as U.S. Patent Application Publication No. US 2025/0182211 A1 (US20250182211A1) on Jun. 5, 2025 (the “Parent Application”).

The inventor is also a named inventor on, and this application is related to, the following U.S. patent application publications (each of which is incorporated by reference as set forth below):

US 2025/0005638 A1 (US20250005638A 1), entitled “Aggregating Asset Value and Marshalling Cooperation to Achieve Economic Benefits and Social Good,” filed Oct. 27, 2023 (application Ser. No. 18/384,658) and published Jan. 2, 2025.

US 2025/0005670 A1 (US20250005670A 1), entitled “Asset Allocation for Optimization of Collective Economic Benefit,” filed Jun. 29, 2023 (application Ser. No. 18/216,329) and published Jan. 2, 2025.

US 2025/0156959 A1 (US20250156959A1), entitled “Computer-Implemented Systems and Methods for Dispersion of Closing Cycles,” filed Nov. 14, 2023 (application Ser. No. 18/509,023) and published May 15, 2025.

US 2024/0330865 A1 (US20240330865A1), entitled “System and Method of Cooperatively Optimizing Compensation Benefits for Employer and Worker,” filed Mar. 29, 2023 (application Ser. No. 18/128,041) and published Oct. 3, 2024.

US 2023/0214920 A1 (US20230214920A1), entitled “Method of Supplying Loaned Funds to Employees for Increased Participation in Broad-Based Employee Stock Ownership Plans,” filed Mar. 9, 2023 (application Ser. No. 18/119,507) and published Jul. 6, 2023.

US 2021/0295432 A1 (US20210295432A1), entitled “Method and System of Supplying Loaned Funds to Employees for Increased Participation in Employee Stock Option Plans,” filed May 28, 2021 (application Ser. No. 17/333,363) and published Sep. 23, 2021.

US 2016/0225081 A1 (US20160225081A1), entitled “Method and System of Supplying Loaned Funds to Employees for Increased Participation in Employee Stock Option Plans,” filed Feb. 4, 2015 (application Ser. No. 14/613,535) and published Aug. 4, 2016.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE

Not applicable. No computer program listing appendix, no sequence listing, and no large table is submitted herewith on a compact disc or as a text file.

### STATEMENT REGARDING PRIOR DISCLOSURES BY THE INVENTOR OR A JOINT INVENTOR

Not applicable. Any disclosures by the inventor relevant to this application are reflected in the related U.S. patent application publications identified in the Cross-Reference section.

### INCORPORATION BY REFERENCE

The entire disclosures of the Parent Application and each of the U.S. patent application publications identified in the Cross-Reference section are incorporated by reference herein in their entireties, to the extent permitted by applicable law and regulations. In the event of any inconsistency between an incorporated disclosure and the explicit disclosure herein, the explicit disclosure herein controls.

### FIELD OF THE INVENTION

The present disclosure relates to computer-implemented systems and methods for allocating and reconfiguring ownership and usage rights in assets and asset-like rights to maximize collective economic benefit. More particularly, the disclosure relates to receipt-native, event-sourced computing architectures that (i) use AI to predict efficient use and select specialized ownership entities, (ii) execute ownership transfer while preserving usage continuity, (iii) compress transaction and coordination overhead via netting and atomic execution, and (iv) generate cryptographically verifiable receipt chains enabling deterministic replay, auditability, and policy-governed automation across domains.

### BACKGROUND OF THE INVENTION

The Background section is provided to place the disclosed subject matter in context. It is not an admission that any referenced material, or any characterization of material as “conventional” or “known,” constitutes prior art. Applicant expressly reserves the right to contest the status of any such material as prior art.

Across finance, labor, benefits, insurance, and asset utilization markets, value and risk are commonly mediated by layers of intermediaries: brokers, agents, platforms, clearinghouses, auditors, and administrative vendors. These intermediaries often exist because (a) the underlying resources are constrained by law, policy, and contract; (b) rights are bundled together in ways that make partial transfer or optimization difficult; and (c) systems lack a shared, verifiable coordination and audit layer.

In this disclosure, these intermediaries are treated as “middlemen” in a broad technical sense: any actor or system that exists primarily to bridge fragmented state, reconcile duplicated records, enforce policy via manual workflows, or monetize coordination through per-transaction fees. Examples include, without limitation, brokers and agents, payment processors and clearing intermediaries, benefits administrators and recordkeepers, managers and approval chains inside organizations, and reconciliation/audit layers that exist because systems are not deterministic, not interoperable, and not natively auditable. The disclosed architecture reduces or removes these middlemen by internalizing coordination into a receipt-native control plane: the system makes policy-aware decisions, executes (or pre-authorizes) netted transactions, and produces machine-verifiable evidence (typed receipts) sufficient for audit, dispute resolution, and regulated reporting.

The result is waste in several forms: duplicated records, reconciliation and reporting ‘busy seasons,’ excessive gross settlement volume, opaque audit trails, avoidable fees and spreads, and locked or forfeited value (e.g., employees failing to capture benefits such as ESPP discounts or retirement matches due to liquidity and withholding constraints).

Conventional approaches address isolated pain points (e.g., a point solution lender advancing funds for a benefit purchase), but they introduce new intermediaries and do not generalize across domains. Additionally, as AI is introduced into sensitive workflows, systems often lack consistent governance, traceability, and evidence artifacts that can be replayed and audited.

Some systems provide digital or “smart” receipts for purchases or services, including receipt wallets and merchant-hosted receipt repositories. These systems typically treat a receipt as a consumer-facing artifact rather than as a canonical, typed execution trace that is (i) deterministically replayable and (ii) sufficient to reconstruct the authoritative state of an ownership-allocation workflow across heterogeneous systems.

Other systems provide tamper-evident logging (e.g., append-only logs using hash chaining, Merkle roots, and inclusion proofs). While such logs provide integrity and sequence guarantees, they are often agnostic to the semantics of ownership/usage separation, and they do not consistently bind (a) AI model provenance, (b) policy/rulepack provenance, and (c) pre-state/post-state digests into each state transition needed to prove that an ownership-allocation decision was executed correctly under applicable jurisdictional, contractual, and risk constraints.

Event-sourced and write-ahead-log architectures can replay events to reconstruct application state, but without a standardized receipt grammar, proof-carrying witness bundles, and policy-gated privileged actions, it can be difficult to support third-party verification, selective disclosure, and cross-domain composability (e.g., spanning benefits, payroll, banking, insurance, and asset-utilization markets) while simultaneously reducing settlement legs and reconciliation overhead.

There remains a need for computing systems that can (i) detach ownership from usage in a controlled, repeatable way, (ii) treat legal/tax/regulatory barriers as machine-checkable constraints rather than post-hoc human review, (iii) internalize and compress transaction steps so fewer middlemen are required, and (iv) produce deterministic, cryptographically verifiable records of what happened and why.

### SUMMARY OF THE INVENTION

The disclosed receiptized ownership-allocation platform provides a practical application implemented in computing systems, including improvements in integrity, auditability, storage, latency, and security. Non-limiting examples of technical effects include:

Deterministic replay of system state from a canonical, hash-linked sequence of typed receipts, enabling reproducible audit without reliance on mutable databases.

Bounded replay and verifier time via replay-manifest receipts and checkpoint roots that permit deterministic reconstruction and spot-checking of a workflow window.

Credential revocation/suspension and policy-epoch transitions via status receipts or status lists referenced by usage credentials and governance gates.

Cryptographic integrity and tamper-evidence using content-addressed receipts, checkpoint receipts, and Merkle-or vector-commitment roots, optionally anchored to an external tamper-evident log.

Transaction compression via (i) deduplication of shared witness objects, and (ii) multilateral netting and reduction of settlement legs subject to setoff-right constraints, reducing network messages and reconciliation work.

Reduced compute and storage footprint for AI/ML inference by quantizing model weights and/or activations and executing inference on a hardware accelerator, with optional shard migration/prefetch to reduce access latency.

Security improvement by fewer settlement handoffs, exactly-once/idempotent execution semantics, and receipt-based gating of privileged actions under a versioned policy rulepack.

Selective disclosure and privacy controls, including encrypted receipt payloads, key-rotation, field-level redaction, and optional proof-carrying receipts (e.g., inclusion proofs) for third-party verification.

In embodiments, a computer system receives information about a participant (user, household, organization) and an asset (or asset-like right), ingests historical utilization and outcome data, and executes an AI/ML categorization engine (optionally on specialized hardware) to produce a predicted most-efficient-use configuration for the asset. The system compares the prediction to observed usage/ownership state, detects a threshold inefficiency, and selects a specialized ownership entity that maximizes expected collective economic benefit subject to constraints. The system then encodes and executes a transaction transferring legal title to the selected entity while preserving usage rights for the participant, and stores benefit-sharing parameters for redistribution.

In embodiments, the disclosed platform enhances ownership-allocation operations by wrapping execution in a receipt-native technical spine: a formal receipt grammar, a universal receipt ledger, and deterministic replay. The result is a verifiable, compressible record of state transitions that supports independent auditing and policy compliance without requiring access to proprietary internal databases.

Optional modules further compress and secure workflows: multilateral netting of obligations across a consented clearing group, atomic multi-rail settlement using prepare/commit/rollback semantics, policy lattices/rulepacks that compile jurisdiction-and plan-specific constraints into machine-enforceable gates, selective disclosure mechanisms, controlled redaction under governance, and surplus measurement and distribution engines that route measurable efficiency gains to participants and buffers.

### BRIEF DESCRIPTION OF THE DRAWINGS

FIG. 1 is a block diagram of an example receiptized ownership allocation system 100 including one or more client devices 110, a network 115, a receiptized ownership allocation platform 120, and one or more external settlement rails 180.

FIG. 2 is a flow diagram of an example receiptized ownership allocation loop 200 executed by the platform 120 to ingest asset/participant state, evaluate inefficiency, select a specialized ownership entity, execute ownership transfer while preserving usage rights, and commit receipts with checkpointing and witness bundles.

FIG. 3 is a schematic diagram of an example canonical receipt data structure 300 defined by a receipt grammar, including typed fields for parties 302, asset identity 304, rights/obligations 306 (optionally including policy identifiers and/or hashes), signatures/attestations 308, cryptographic commitments 310, and idempotency keys 312.

FIG. 4 is a schematic diagram of an example universal receipt ledger 400, including an append-only receipt store 402, a checkpoint chain 404, Merkle/state-root anchors 406, and a witness-object store 408.

FIG. 5 is a schematic diagram of bounded deterministic replay 500 using a replay manifest 502, a receipt subset 504, input digests 506, and verifier-side recomputation 508.

FIG. 6 is a schematic diagram illustrating separation of ownership from usage in an ownership/usage arrangement 600, including conveyance to a specialized ownership entity 630, issuance of a usage agreement or credential 640 to a user 610 for an asset 620, and computation and distribution of surplus value 650.

FIG. 7 is a schematic diagram of an example policy lattice and rulepack pipeline 700 that compiles jurisdictional and program constraints 702 into machine-checkable predicates 704 bound to receipts via rulepack hashes 706.

FIG. 8 is a schematic diagram of settlement preparation 800, including gross obligations/legs 802, netting/compression 804, and settlement manifest(s) 806.

FIG. 9 is a schematic diagram of example privacy controls 900, including selective disclosure 902, key management 904, a zero-trust envelope 906, key rotation 908, controlled redaction 910, and audit receipts 912.

FIG. 10 is a schematic diagram of example edge inference hardware and data-path optimizations 1000, including an AI accelerator (ASIC/NPU) 1002, quantized memory layouts 1004, and optional hardware accelerators 1006.

FIG. 11 is a block diagram of an example employee-benefits embodiment 1100 (e.g., employer matching, ESPP/ESOP participation, retirement accounts) where ownership/benefit entitlements are modeled as assets and optimized with receiptized governance and deterministic replay.

FIG. 12 is a block diagram of an example year-end and accounting embodiment 1200 where receipts encode close-cycle events, confirmations, and audit evidence, enabling deterministic replay and transaction compression across reporting cycles. FIG. 13 is a block diagram of an example dataset-shard migration embodiment 1300 in which dataset shards 1314, 1324 are migrated between distributed memory devices 1312, 1322 in different geospatial data centers 1310, 1320 under control of a shard migration controller 1340 implementing a latency-or-cost heuristic 1330 and using a cache/prefetch layer 1350 to sustain low-latency access for a regional compute cluster/AI kernel 1360.

### DETAILED DESCRIPTION OF THE INVENTION

The following detailed description describes example implementations of receiptized ownership allocation systems and methods. In embodiments, the disclosed platform uses a universal, append-only receipt ledger and deterministic replay to create verifiable, compressible, and policy-governed workflows that detach ownership from usage, select specialized ownership structures using AI/ML, and execute transactions with fewer intermediaries, fewer settlement handoffs, and improved auditability.

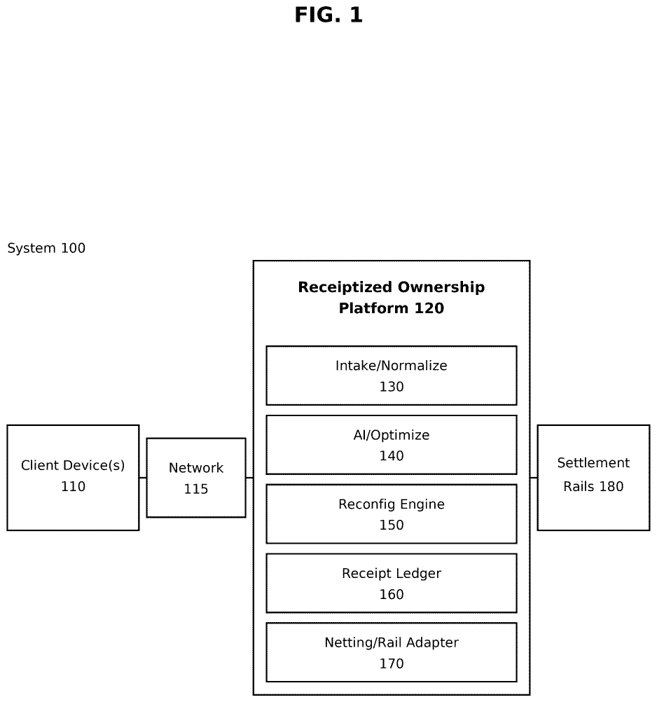

Referring to FIG. 1, an example system 100 includes one or more user devices 110 (e.g., mobile devices, desktops, kiosks, point-of-sale devices, and/or IoT devices) coupled to a receiptized ownership allocation platform 120 via a network 115. The platform 120 can include: (i) an intake and normalization module 130 configured to receive participant and asset information (including usage, ownership structures, and constraints), normalize and canonicalize inputs, and compute input digests; (ii) an AI/optimization kernel 140 configured to generate a predicted most-efficient-use vector for the asset and to rank candidate ownership entities; (iii) a reconfiguration engine 150 configured to encode and execute a conveyance record and a usage-preservation record that transfers legal title to a selected ownership entity while preserving usage rights for the participant; (iv) a universal receipt ledger 160 configured to append typed receipts and checkpoints and to support deterministic replay using witness bundles; and (v) a settlement/netting and rail-adapter module 170 configured to compress and/or net obligations and to execute settlement instructions via one or more external settlement rails 180. In embodiments, external systems and data sources (not shown) can include payroll systems, benefits administrators, banking cores, custody systems, marketplaces, insurers, registries, and identity providers.

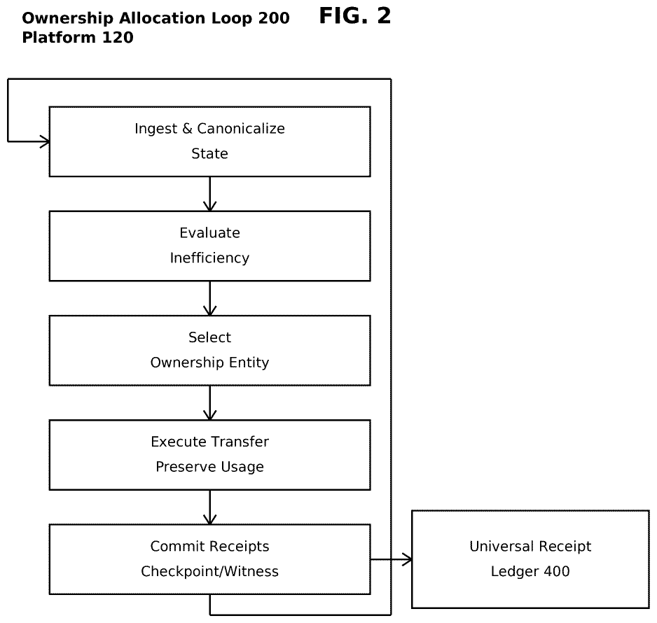

Referring to FIG. 2, the platform 120 can execute a receiptized ownership allocation loop 200 that (i) ingests and canonicalizes asset/participant state into receipts, (ii) evaluates inefficiency or suboptimal ownership/usage configurations, (iii) selects a specialized ownership entity subject to constraints, (iv) executes an ownership transfer while preserving usage rights, and (v) commits receipts to the universal receipt ledger 400 with checkpointing, replay manifests, and witness bundles to enable deterministic replay by a verifier device.

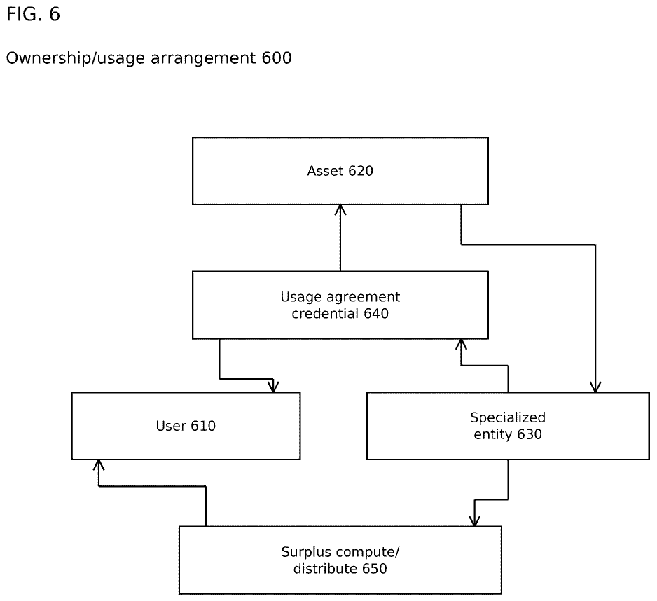

Referring to FIG. 6, ownership can be separated from usage by conveying legal title of the asset 620 to a specialized ownership entity 630 while issuing a usage agreement or credential 640 to the user 610. Receipts can encode the conveyance, the usage rights, and any surplus distribution parameters 650.

### 6. DEFINITIONS AND TERMINOLOGY

For clarity, the following terms are used throughout this disclosure. Unless otherwise indicated, these definitions are illustrative and do not limit claim scope.

Asset. Any tangible or intangible resource, right, entitlement, capacity slice, obligation stream, or financial/contractual position that can be modeled as an object with ownership attributes and usage attributes. Examples include real property, vehicles, equipment, subscription seats, GPU time-slices, ESPP purchase rights, retirement match rights, insurance coverage rights, payroll and benefit obligations, and work parcels.

Ownership Entity (Specialized Entity). A legal or logical entity capable of holding legal title or economic ownership interests in an asset. Examples include SPVs, trusts, mutual pools, foundations, nonprofits, employer-of-record entities, clearing-group entities, and other structures optimized for tax, risk, governance, or operational constraints.

Usage Rights. Rights to possess, access, consume, or otherwise use an asset without necessarily holding legal title. Usage rights can be represented as leases, rentals, subscriptions, time-slices, mile-slices, service-level entitlements, or usage-only tokens.

Ownership-from-Usage Separation. A reconfiguration in which legal title is transferred to an ownership entity while usage rights are preserved for a user via a usage agreement, token, or other access mechanism.

Receiptized/Receiptization. A process in which workflow steps or state transitions are recorded as typed receipts conforming to the receipt grammar and appended to the Universal Receipt Ledger, such that the workflow can be deterministically replayed and independently verified without reliance on mutable internal databases.

Typed Receipt. A structured record classified by a receipt_type and formatted according to the canonical receipt format, including at least identifiers, timestamps, input digests, output digests, policy/model references, and one or more signatures, such that the record can be validated, linked, checkpointed, and used for deterministic replay.

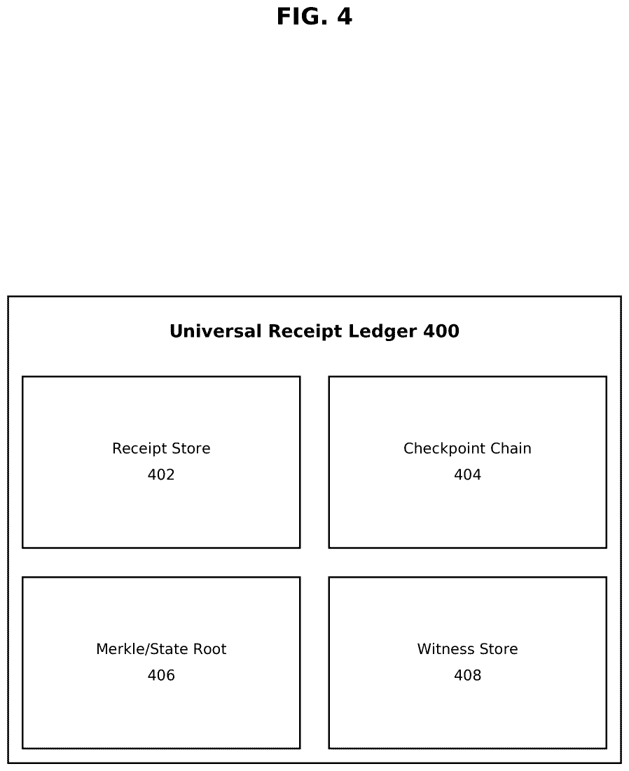

Universal Receipt Ledger (URL) (see FIG. 4). An append-only, tamper-evident ledger storing typed receipts that represent system events, decisions, policy gates, and execution outcomes. Receipts can be hash-linked and checkpointed to support deterministic replay and audit.

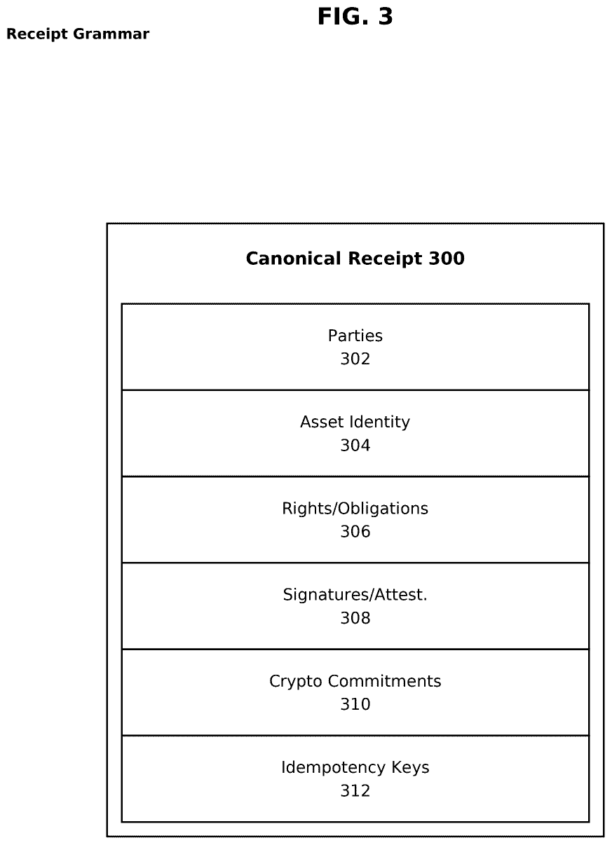

Receipt Grammar (see FIG. 3). A formal definition of required receipt fields, valid sequences of receipts for a workflow, correlation-id rules, and idempotency/exactly-once constraints. The grammar enables duplicate suppression, out-of-order detection, and deterministic replay of multi-step processes.

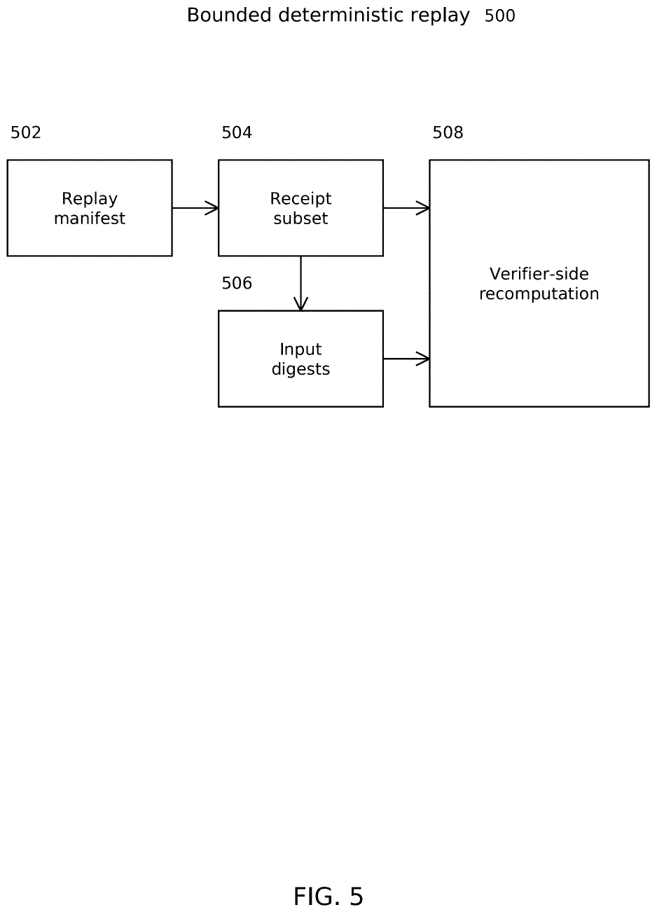

Deterministic Replay (see FIG. 5). Reconstruction of system state and verification of outcomes by replaying a sequence of receipts (optionally from a checkpoint) such that a verifier obtains the same results for the same inputs, within defined tolerances.

Replay Manifest. A deterministic, receipt-addressed object that enumerates an ordered set of receipt identifiers and expected digests for a bounded replay window (e.g., a settlement cycle, policy epoch, asset lifecycle event, or dispute window), enabling a verifier to deterministically fetch the minimum receipt subset needed to replay and validate a target transition.

Consistency Proof. A cryptographic proof that a later committed root (e.g., a Merkle root) is an append-only extension (superset) of an earlier committed root, permitting verification that the ledger grew without rewriting prior history.

Status List/Status Receipt. A space-efficient status publication mechanism (e.g., a bitstring, bitmap, or compressed status vector) that encodes validity, suspension, revocation, or eligibility state for one or more credentials, usage-rights tokens, policy packs, or participants, and that is referenced by receipts to support revocation-aware deterministic replay.

Retention Receipt/Redaction Receipt. A typed receipt that records an allowed retention, deletion, or redaction action under an applicable policy rulepack, and that binds (i) a reference to the original receipt(s), (ii) a redaction predicate or retention window, and (iii) a continuity proof (e.g., hash commitments or chameleon-hash updates) so that deterministic replay remains possible over non-redacted portions.

Verifier Device. A computing device (e.g., auditor workstation, regulator portal, counterparty system, end-user device) that validates a witness bundle by verifying signatures, inclusion/consistency proofs, and replayed state roots without requiring direct access to internal mutable databases of the platform.

State Root. A cryptographic digest that commits to a defined subset of platform state at a given point in the receipt stream. A state root can be computed over canonicalized state data structures and can be replayed and recomputed from typed receipts to verify that the replayed state matches the recorded state.

Normalized Inputs. A deterministic representation of inputs to a receiptized step. Normalization can include canonical serialization, deterministic field ordering, numeric normalization/rounding rules, timezone normalization for timestamps, and stable reference resolution for external identifiers, such that identical semantic inputs yield identical input digests.

Model Artifact. A versioned set of model parameters and (optionally) executable inference logic used by the artificial-intelligence categorization engine. A model artifact can be addressed by a cryptographic digest and referenced by a model identifier in typed receipts to permit deterministic replay and verification of outputs.

Inclusion Proof. A cryptographic proof that a particular typed receipt (or its digest) is included in a committed portion of the universal receipt ledger (e.g., via a Merkle proof to a checkpoint root), optionally together with a consistency proof that the committed portion is an append-only extension of a prior commitment.

Witness Bundle. A proof-carrying evidence package that includes a minimal closure of receipts, proofs, and dependencies required for a verifier to replay and validate a target receipt or workflow without needing access to internal databases.

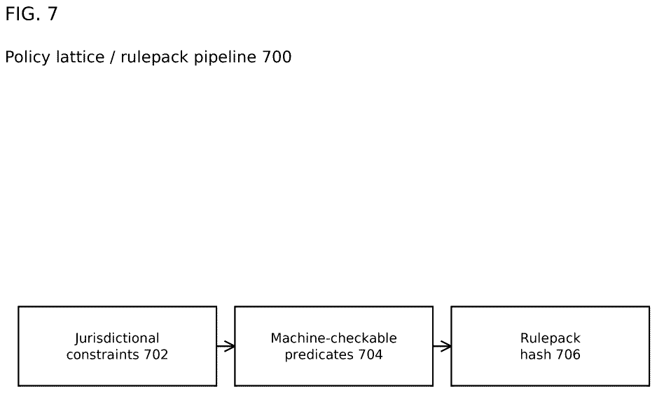

Policy Lattice/Rulepack (see FIG. 7). A versioned, jurisdiction-and context-specific bundle of constraints (legal tests, thresholds, plan rules) compiled into machine-checkable predicates. Rulepacks may be hashed and bound into receipts to pin the exact rules used for a decision.

Settlement Identifier. A per-cycle reference that deterministically links settlement legs and receipts; may be propagated into payment messages (e.g., ISO 20022 EndToEndId) and cross-border tracking identifiers (e.g., UETR).

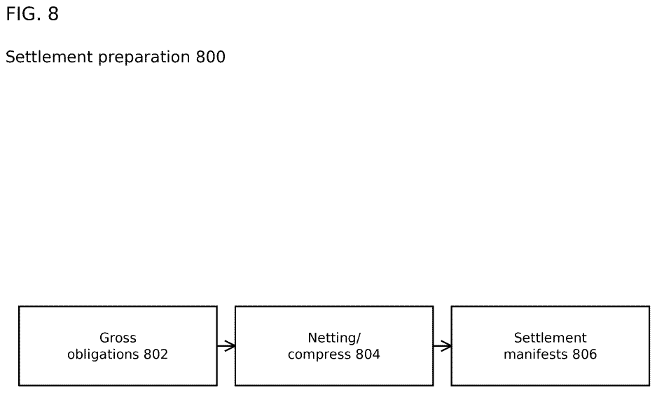

Multilateral Netting (see FIG. 8). An optimization that offsets reciprocal obligations across a consented clearing group to minimize gross settlements, subject to setoff-right constraints. Produces a net payable/receivable per party and a Proof-of-Netting receipt.

Hierarchy-of-Needs Allocation. A tiered distribution policy that routes net receipts first to essential obligations, then to financial-security obligations, and only then to discretionary or growth uses; allocations emit Proof-of-Benefit receipts bound to a cycle.

Trust Coefficient. A dynamic reliability measure derived from evidence-rich receipts and settlement behavior; used to adjust reserves, risk budgets, access tiers, and pricing.

Surplus Value. A measured efficiency gain attributable to optimization (e.g., gross-notional reduction, retries avoided, capacity reutilization). Surplus may be routed by a distribution ruleset and recorded in surplus receipts.

Proof Receipts. Typed receipts evidencing key computations or outcomes. Examples include Proof-of-Classification (PoC), Proof-of-Netting (PoN), Proof-of-Benefit (PoB), settlement manifests, checkpoint receipts, and policy-gate receipts.

### 7. SYSTEM ARCHITECTURE (RECEIPTIZED OWNERSHIP ALLOCATION PLATFORM) IMPLEMENTATION PREREQUISITES AND INTEROPERABILITY CONSTRAINTS (NON-LIMITING)

Implementations that provide deterministic replay and audit-grade proofs over ownership-transfer events typically satisfy one or more of the following prerequisites. These are disclosed as enabling details and also illustrate concrete technical requirements that a third party would need to implement to obtain the same deterministic, replayable behavior:

A canonical receipt format (receipt grammar) with deterministic serialization rules (e.g., field ordering, numeric normalization, and stable encoding) so that the same inputs yield the same input digests. As shown in FIG. 3, an example canonical receipt 300 can include parties/participants 302, asset identity 304, rights/obligations 306 (optionally including policy references and/or hashes), signatures/attestations 308, cryptographic commitments 310, and idempotency keys 312.

Hash-linked receipt sequencing and periodic checkpointing (state roots) so that tampering with any receipt is detectable and replay can be bounded.

Replay-manifest receipts and consistency proofs (append-only extension proofs) so a verifier can confirm that a later ledger root extends an earlier root and can fetch a minimal ordered receipt subset for bounded replay.

Idempotency keys and exactly-once semantics enforced by the receipt grammar so that retried operations do not produce divergent state.

A signed, versioned policy identifier bound into receipt metadata, and a policy-rulepack verification step gating privileged actions (e.g., ownership transfer, netting, or redaction).

Key-management for receipt signatures, including key rotation and revocation, and optionally hardware-backed key storage or enclave-based signing.

Status receipts or status lists for revocation/suspension of usage credentials and verifiable credentials, enabling revocation-aware policy gating and deterministic replay without querying issuer systems.

A witness-object store for bulky evidence (documents, proofs, model artifacts, data shards) referenced by hash from receipts, enabling deduplication and storage compression.

A deterministic replay engine that can reproduce selected state transitions from receipts and verify integrity by recomputing digests and comparing to stored digests and/or anchored roots.

Interoperability adapters to transactional rails (payments, payroll, brokerage, custody, insurance, tax) that emit settlement receipts and map external identifiers into the ledger correlation identifiers.

FIG. 1 (conceptual). A receiptized ownership-allocation platform includes (i) an intake and normalization layer, (ii) an AI/optimization kernel aligned to the core ownership-allocation operations, (iii) an ownership-usage reconfiguration engine, (iv) a Universal Receipt Ledger with deterministic replay and witness bundles, and (v) optional modules for policy-lattice gating, netting/compression, cross-rail settlement, privacy/security, and surplus distribution.

### 7.1 Intake and Normalization Layer

The intake layer receives state about a participant and an asset used or to be used by the participant. In embodiments, the system ingests asset-utilization transaction data containing historical sale, lease, usage, and profile records for a participant-asset pair and retrieves supplemental datasets (economic outcomes, demographics, risk signals, market conditions, and other context).

The system normalizes the ingested data into structured objects, including: (i) an AssetRecord describing the asset and its current ownership and usage state, (ii) a ParticipantRecord describing the participant (or household) and relevant constraints, (iii) an OwnershipEntityGraph listing candidate specialized entities and their capabilities/constraints, and (iv) an EvidenceGraph of receipts, credentials, and policy nodes.

### 7.2 AI/Optimization Kernel (Allowance-Aligned)

Allowance-aligned AI enablement (representative). In some embodiments, the AI/ML categorization engine is executed using a neural-network hardware accelerator, such as an application-specific integrated circuit (ASIC) comprising arrays of neurons, synaptic circuits storing weights, and one or more hidden layers using non-linear activation functions (e.g., ReLU and sigmoid) to identify patterns, correlations, and relationships in the ingested asset-utilization transaction data. The kernel may be trained on historical datasets including parameters for business sale transaction information, asset usage, ownership structures, and economic outcomes, and outputs a predicted most-efficient-use vector for the asset. In some embodiments, each neuron in the array comprises a register, a processing element, and at least one input. In some embodiments, neurons are interconnected via synaptic circuits each comprising a memory configured to store a synaptic weight, such that each neuron is connected to at least one other neuron via a synaptic circuit. In some embodiments, the ASIC includes circuitry operable to execute a functionally invariant path (FIP) algorithm to update network weights along differential-geometry paths so as to preserve learned behavior while increasing sparsity.

Quantization and memory-footprint reduction (representative). In some embodiments, neural-network weights and/or activations are stored as 32-bit floating-point variables and are statically quantized (e.g., to 8-bit integers) for inference and/or storage, thereby reducing storage footprint and enabling lower-latency execution on constrained or distributed hardware. Quantization parameters (e.g., scale and zero-point), calibration dataset identifiers, and model hashes may be bound into a ModelReceipt or AIDecisionReceipt to support deterministic replay and to evidence that the same quantization configuration was used when generating a prediction. In a representative embodiment, the neural-network weights and the neural-network activations are stored as 32-bit floating-point variables and are statically quantized as 8-bit integers for inference and/or storage, wherein the neural-network weights are quantized to reduce storage footprint.

Supervised training loop (representative). In some embodiments, supervised learning is used wherein labeled datasets with known inputs and desired outputs are fed into the network; the network adjusts internal weights via backpropagation to minimize a loss function (e.g., mean squared error), iteratively refining predictions until an error metric falls below a predefined threshold. Training metadata (dataset digests, model version IDs, loss curves, stopping criteria) may be captured in one or more TrainingReceipt objects and linked to subsequent AIDecisionReceipt objects using a model-hash reference. In some embodiments, the training process is executed by the neural-network hardware accelerator (e.g., the ASIC), and the ASIC iteratively refines predictions until the error metric falls below the predefined threshold.

Deterministic inference for replay (representative). To permit deterministic replay of AI outputs across hardware and time, the platform may record, in one or more typed receipts, a model artifact identifier (e.g., a cryptographic hash of weights and configuration), a quantization configuration, an inference-runtime identifier (e.g., framework/library version and determinism flags), random seeds (if applicable), and numeric precision/rounding modes. In some embodiments, model execution is confined to a verified container or trusted execution environment whose measurement hash is bound into the receipt, enabling a verifier to reproduce an output digest from the same normalized inputs.

Functionally-invariant continual learning (FIP) (optional). In some embodiments, the system updates models using a functionally invariant path (FIP) algorithm that updates network weights along differential-geometry paths to preserve learned behavior while increasing sparsity and/or accommodating new evidence. An FIP update may be performed on newly accumulated asset-utilization transaction data. The system may emit a ModelUpdateReceipt binding (i) a prior model hash, (ii) a new model hash, (iii) an update window or cohort selector, (iv) an FIP configuration identifier, and (v) invariance metrics demonstrating preservation of prior behavior, thereby supporting continual learning without destabilizing prior allocations.

Geospatial shard migration for low-latency access (optional). In some embodiments, datasets used by the receiptized ownership-allocation loop are stored as shards across distributed memory devices in different geospatial data centers. The system migrates, replicates, caches, and/or prefetches dataset shards when a latency-or-cost heuristic is satisfied to sustain parallel low-latency access for evaluation and optimization runs. For example, the system may move frequently accessed shards closer to a regional compute cluster, replicate shards for redundancy, or prefetch anticipated shards prior to a scheduled optimization cycle. Dataset-shard operations may be recorded as DatasetShardReceipt objects binding (i) a shard identifier, (ii) a source location, (iii) a destination location, (iv) a heuristic decision record, and (v) cryptographic digests enabling later replay of which data was available for a given decision. In some embodiments, shard-migration operations include caching frequently accessed data and prefetching anticipated data to reduce access latency. FIG. 13 illustrates an example architecture in which geospatial data centers 1310, 1320 store dataset shards 1314, 1324 on distributed memory devices 1312, 1322, and a shard migration controller 1340 applies a latency-or-cost heuristic 1330 and uses a cache/prefetch layer 1350 to migrate shards and sustain low-latency access for a regional compute cluster/AI kernel 1360.

The AI/optimization kernel produces a predicted most-efficient-use configuration for the asset and selects an ownership entity that maximizes expected collective economic benefit. In embodiments, the kernel uses a neural network executed on specialized hardware (e.g., an ASIC neural network) and includes storage-footprint and continual-learning mechanisms such as static quantization and sparsity-preserving weight-update paths. The kernel may be trained using supervised learning over historical datasets, producing a predicted efficient-use vector.

In operation, the kernel compares the predicted efficient-use configuration to the participant's declared or observed usage state to compute an inefficiency delta. If the delta meets or exceeds a threshold, the kernel triggers a structure-selection and actuation phase to reconfigure ownership while preserving usage continuity In some embodiments, the platform flags, in a data structure, a projected differential meeting or exceeding a predefined threshold ownership inefficiency (e.g., via an AssetRecord and/or an InefficiencyDeltaReceipt).

### 7.3 Ownership-Usage Reconfiguration Engine

The reconfiguration engine encodes and executes transactions that transfer legal title to a selected specialized ownership entity while preserving usage rights for the participant. In a representative embodiment, the engine generates (i) a conveyance record designating the selected entity as owner and (ii) a usage-agreement record granting the participant possession or access under a lease, rental, subscription, or other long-term usage arrangement.

The engine stores executed records in a database of assets, ownership entities, participants, and policies. The engine also computes a benefit-sharing parameter to redistribute a portion of the maximized benefits to the participant, thereby creating an incentive-compatible participation loop.

### 7.4 Universal Receipt Ledger and Receipt Grammar

The Universal Receipt Ledger stores typed receipts for each significant step in the workflow. Receipts may include policy checks, AI model provenance, predicted vectors, selected entities, conveyance/usage-agreement digests, netting outcomes, settlement confirmations, and alerts. Receipts are canonicalized into a deterministic field ordering and cryptographically hashed and signed. As shown in FIG. 4, an example universal receipt ledger 400 can include an append-only receipt store 402, a checkpoint chain 404, Merkle/state-root anchors 406 (e.g., a Merkle/digest builder configured to compute state roots over a receipt graph), and a witness-object store 408 for content-addressed evidence objects.

A receipt grammar defines: (i) required receipt types and fields; (ii) correlation identifiers linking receipts within a workflow; (iii) valid sequences (e.g., policy-gate receipts preceding execution receipts); and (iv) idempotency/exactly-once rules so repeated external events or retries do not produce duplicate economic effects.

### 7.5 Deterministic Replay and Witness Bundles

To enable deterministic replay, the ledger emits checkpoint receipts that commit to a state root at defined intervals (e.g., block height, pay cycle close, or policy epoch). A verifier can start from a checkpoint and replay subsequent receipts to reconstruct state transitions. FIG. 5 illustrates deterministic replay verification 500 in which a replay manifest 502 selects a receipt subset 504 and associated input digests 506, enabling verifier-side recomputation 508 of state transitions from a checkpointed state root.

In embodiments, the system constructs witness bundles for stateless verification. A witness bundle may include: (i) the relevant checkpoint receipt, (ii) the minimal set of receipts required to recompute a target state transition, (iii) inclusion proofs (e.g., Merkle paths) for the receipts and referenced proof nodes, (iv) schema identifiers and version pins, and (v) signatures and time-stamp tokens. A verifier can validate the witness bundle without querying internal databases, thereby supporting auditor-grade verification and lightweight clients.

Replay manifests (representative). In some embodiments, the receipt engine generates a ReplayManifestReceipt for each replay window (e.g., per settlementCycleId, per policyEpochId, per assetLifecycleId, or per disputeWindowId). The ReplayManifestReceipt binds (i) a checkpoint receipt identifier, (ii) an ordered list or range expression of receipt identifiers within the window, (iii) a deterministic ordering rule (e.g., sequence numbers with tie-breakers), and (iv) an expected terminal state root for the window, thereby enabling bounded deterministic replay and minimizing verifier fetch cost.

Representative bounded replay algorithm. A verifier device may: (a) retrieve a ReplayManifestReceipt; (b) fetch the referenced checkpoint receipt and a minimal ordered subset of receipts; (c) verify inclusion and consistency proofs for fetched receipts against the checkpoint and/or an anchored root; (d) re-execute the platform's deterministic state transition function(s) over the ordered receipts; and (e) confirm that a recomputed terminal state root matches the expected terminal state root recorded in the ReplayManifestReceipt.

Revocation-aware replay. Where usage credentials, policy packs, or participant attestations are revocable or suspendable, the witness bundle may include a StatusListReceipt (or a compact status vector referenced by hash) such that the verifier can confirm that credentials and rulepacks were valid for the relevant time_labels and policy epoch when the platform executed an ownership reassignment or settlement step.

Retention and controlled redaction. In some embodiments, the witness bundle additionally includes RetentionReceipt and/or RedactionReceipt objects that prove an allowed redaction or deletion action occurred under a governing policy rulepack, while preserving deterministic replay over non-redacted portions via continuity proofs and updated commitments.

### 7.6 Optional Modules (Policy, Netting/Compression, Security, Surplus)

In some embodiments, additional modules share the same receipt substrate and can be claimed as embodiments and/or optional modules:

Policy lattice/rulepack compilation: versioned constraints compiled from law, regulation, plan documents, and governance rules; receipts bind rulepack hashes used for gating. As shown in FIG. 7, an example policy lattice/rulepack gating module 700 can retrieve a rulepack 702 (identified by a version and/or hash), evaluate checkable predicates 704, and bind gating decisions to receipts via rulepack hashes 706.

Multilateral netting and transaction compression: formation of netting sets across a consented clearing group; issuance of Proof-of-Netting receipts and settlement manifests; fewer gross settlement legs. As shown in FIG. 8, transaction compression/netting 800 can operate on gross obligations/legs 802, compute netting/compression results 804, and generate settlement manifests 806 for cross-rail execution.

Cross-rail atomic settlement: prepare/commit/rollback semantics across one or more rails (bank rails and/or programmable rails); correlation identifiers preserved; rollback receipts on failure.

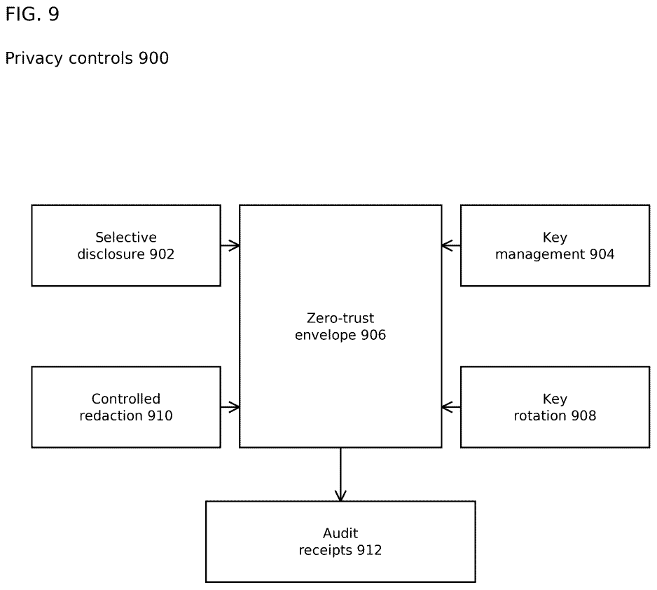

Selective disclosure and privacy: predicate-only matching, disclosure budgets, controlled reveal-after-commit, and zero-trust envelopes; audit receipts for disclosures and redactions. As shown in FIG. 9, a security and privacy fabric 900 can include selective disclosure controls 902, key management 904, a zero-trust envelope 906 for privileged operations, key rotation 908, controlled redaction 910, and issuance of audit receipts 912 for disclosure/redaction events.

Surplus measurement and regenerative routing: compute measurable surplus (fees avoided, retries avoided, utilization gains); route surplus to participants, buffers, and community pools under distribution rules; issue surplus receipts.

### 8. Data Structures and Receipt Schemas (Representative)

The following schemas are representative. Implementations may use JSON, CBOR, Protobuf, or other encodings so long as the canonicalization rules produce deterministic hashes.

### 8.1 Canonical Receipt Format (CRF)

receipt_id: Deterministic identifier (e.g., hash of canonical fields).
receipt_type: Typed class (e.g., PolicyGateReceipt, AIDecisionReceipt, ConveyanceReceipt, UsageAgreementReceipt, ProofOfNettingReceipt).
correlation_id: Workflow correlation key (may incorporate ISO 20022 EndToEndId/UETR for payment-related steps).
actor_id: Identifier for emitting subsystem or authorized actor.
time_labels: Canonical timestamp plus time-fabric labels (e.g., businessDayId, period_id, settlementCycleId).
policy_refs: Hashes/IDs for applicable rulepacks and policy nodes; optional coverage window.
input_digests: Hashes of inputs consumed (data shards, credential proofs, plan terms, market data).
output_digests: Hashes of outputs produced (predicted vectors, selected entity ID, netting vectors, state roots).
state_root_before/after: Pre/post commitments for the relevant application state subset.
proof_refs: Pointers to proofs/witness chunks (Merkle paths, attestations, model cards, etc.).
signatures: One or more signatures attesting to receipt validity; may include counterparty signatures for bilateral/multilateral steps.

### 8.2 Receipt Canonicalization and Ledger Insertion (Algorithm)

The platform may insert receipts into the Universal Receipt Ledger using a deterministic canonicalization pipeline. A representative algorithm includes:

Receive an event envelope with fields {eventType, actorId, payload, timestampLocal, externalRefs[]}.

Normalize timestampLocal to canonical UTC and time-fabric labels (e.g., businessDayId, settlementCycleId).

Map eventType and payload into a Canonical Receipt Format record with deterministic field ordering (e.g., lexicographically sorted keys or fixed binary encoding).

For referenced proofs (external certificates, model cards, policy packs), compute fixed-algorithm digests and store as separate proof nodes; insert their IDs into proofRef fields.

Compute the receipt hash over the canonical representation; sign the hash; attach stateRootBefore/stateRootAfter commitments as applicable.

Insert the receipt as a node in a Merkle-DAG and update the running spine digest/state root; emit periodic CheckpointReceipts binding the state root to a time anchor.

### 8.3 Exactly-Once/Idempotent Execution via Receipt Grammar

The receipt grammar can enforce exactly-once semantics for multi-step workflows (e.g., sensor event->AI decision->payment->settlement) by requiring that every stage shares a correlation umbrella ID and by defining permitted sequences and uniqueness constraints. If a request is retried, the platform detects an already-present receipt with the same correlation key and suppresses duplicate economic effects.

Representative receipt grammar (non-limiting). In one embodiment, a workflow instance identified by correlation_id conforms to an allowed sequence such as:
AssetIntakeReceipt->ParticipantContextReceipt->(PolicyGateReceipt)*->AIDecisionReceipt->InefficiencyDeltaReceipt->CandidateListReceipt->OwnershipSelectionReceipt->(GovernanceGateReceipt)*->ConveyanceReceipt->UsageAgreementReceipt->BenefitShareReceipt->NotificationReceipt->(ProofOfNettingReceipt|SettlementReceipt)*->CheckpointReceipt->ReplayManifestReceipt. The grammar may further define uniqueness constraints (e.g., exactly one OwnershipSelectionReceipt per correlation_id) and idempotency-key rules for external calls.

In payment-related embodiments, the platform preserves and propagates standard correlation identifiers (e.g., ISO 20022 EndToEndId and SWIFT gpi UETR) into receipts and settlement manifests so that internal and external logs can be matched and duplicates detected end-to-end.

### 8.4 Controlled Redaction (Optional)

In some embodiments, the ledger supports controlled redactions while preserving auditability. A RedactionReceipt may record before/after digests and the authorization quorum signatures. Nodes replaying the ledger see a consistent chain plus evidence that a redaction occurred. Confidential redactions can be logged as public digests with details accessible to authorized regulators.

### 8.5 Ownership Entity Graph

The system may store candidate ownership structures in a graph or database. Each node represents a specialized ownership entity and includes capability and constraint attributes (e.g., eligible asset types, jurisdiction limits, risk budgets, governance rules, reporting posture). Edges may represent transitions, mergers, or wrapper changes permissible under policy.

In embodiments, the predicted most-efficient-use vector is a multidimensional representation whose elements are mapped to canonical units and semantics (e.g., expected after-tax cost, expected utilization, expected risk score, expected compliance posture, expected liquidity impact, expected surplus value, and confidence/uncertainty). The platform may normalize and scale the elements using deterministic transforms so that the same inputs yield the same vector under replay.

In embodiments, an ownership-inefficiency measure (also referred to as an inefficiency delta) is computed as a deterministic distance or divergence between (i) the predicted most-efficient-use vector and (ii) a vector derived from declared usage configuration or observed usage signals. Non-limiting examples include a weighted L1 or L2 norm, cosine distance, a policy-weighted penalty function, or a divergence computed over normalized probability mass functions representing usage allocations.

The platform may persist, in an InefficiencyDeltaReceipt, the metric identifier, weights, normalization transform identifiers, and the applicable threshold identifier (and associated policy/rulepack hash), enabling a verifier device to recompute the same inefficiency measure during deterministic replay and to confirm that actuation occurred only when permitted by the recorded threshold and policy state.

### 8.6 Predicted Efficient-Use Vector

The AI/ML categorization engine outputs a predicted most-efficient-use vector for an asset. The vector may include target ownership attributes (entity type, wrapper class), target usage arrangement parameters (lease term, subscription term, tokenization), expected benefit components (tax savings, risk reduction, utilization gains), and confidence/uncertainty measures.

### 8.7 Netting Vectors and Setoff Masks (Optional)

In embodiments using multilateral netting, obligations are represented as vectors indexed by participant, obligation type, currency, maturity, and policy constraints. A setoff mask encodes whether a given offset is legally/contractually permitted (e.g., mutuality and right-of-setoff requirements), and no-net justification codes are logged when barred.

### 8.8 Witness Bundle Object

A witness bundle is a structured evidence package that provides all receipts and proofs required to verify a target event or window. A minimal witness bundle may include: (i) a starting checkpoint and ending checkpoint, (ii) the receipts within the window, (iii) inclusion proofs for each receipt, (iv) referenced proof nodes (policy packs, model provenance, external settlement confirmations), and (v) a bundle signature.

### 8.9 Replay Manifest Receipt (Representative)

A ReplayManifestReceipt may include: manifest_id (hash), manifest_version, window_id (e.g., settlementCycleId or policyEpochId), checkpoint_receipt_id, ordered_receipt_list (or receipt_range expression), ordering_rule_id, start_state_root, expected_terminal_state_root, consistency_proof_ref(s), and signatures. In some embodiments, the manifest references a compressed representation (e.g., a bitmap, range set, or tile index) for receipt IDs to reduce size.

### 8.10 Status Lists, Revocation Predicates, and Eligibility Gates (Representative)

In some embodiments, usage credentials, verifiable credentials, or policy packs include a revocation predicate that references a status publication. A StatusListReceipt may commit to a compressed status vector (e.g., bitstring or bitmap) indexed by credential identifier or by receipt identifier, and may be periodically updated per policy epoch. During deterministic replay, governance gates validate that any credential or policy pack required for a step was in an allowed status at the time_labels recorded in the receipts.

### 9. CORE WORKFLOW: RECEIPTIZED OWNERSHIP ALLOCATION LOOP

FIG. 2 (conceptual). The platform executes a repeating loop that evaluates an asset's current ownership/usage state, predicts a more efficient configuration, selects an ownership structure, executes ownership transfer while preserving usage, and logs receipts sufficient for deterministic replay.

### 9.1 Step 1—Receive and Ingest Asset/Participant State

The platform receives information about a participant and an asset, including current ownership, current usage pattern, historical utilization transactions, and relevant profile information. Supplemental datasets (economic outcomes, demographic or cohort information, market conditions, and policy context) are retrieved. The platform normalizes the information into structured records.

Receipts emitted may include: AssetIntakeReceipt, ParticipantContextReceipt, and DatasetShardReceipt referencing the specific data shards and versions used.

In embodiments, the platform computes, for each candidate specialized ownership entity, an expected collective economic benefit value from a deterministic objective function that aggregates predicted utility and cost components derived from the predicted most-efficient-use vector. Non-limiting objective terms include (i) reduced after-tax cost or increased after-tax return, (ii) reduced interest, fees, or broker spreads, (iii) increased utilization or reduced idle capacity, (iv) risk reduction or improved reserve efficiency, (v) reduced settlement legs and reconciliation overhead via transaction compression, and (vi) increased surplus value available for distribution or reinvestment.

Constraints applied during selection can be encoded as machine-checkable predicates in the policy lattice/rulepack, including regulatory eligibility rules, tax posture constraints, plan/benefit restrictions, jurisdictional transfer restrictions, counterparty limits, risk budgets, and governance approvals. The platform may evaluate the objective function subject to the constraints using deterministic solvers (e.g., ranking heuristics, linear/integer programming, or bounded search), and may record, in an OwnershipSelectionReceipt, identifiers/hashes of the objective function definition, constraint set, and the selected entity to enable third-party deterministic replay of the selection.

### 9.2 Step 2—Predict Efficient Use and Detect Inefficiency

The platform executes the AI/ML categorization engine to output a predicted most-efficient-use vector for the asset. The prediction is compared to observed usage to compute an inefficiency delta. If the delta exceeds a configured threshold, the workflow proceeds to structure selection and actuation; otherwise, the asset remains in its current configuration.

Receipts emitted may include: AIDecisionReceipt, InefficiencyDeltaReceipt, and optional GovernanceGateReceipts for AI use.

### 9.3 Step 3—Select Specialized Ownership Entity Under Constraints

The platform queries an ownership-entity database/graph and returns a ranked candidate list of specialized entities. The platform computes an expected collective economic benefit score for candidates, subject to constraints derived from policy lattices/rulepacks (jurisdiction, plan rules, governance limits, risk budgets). The platform selects the top-ranked candidate that satisfies constraints.

Receipts emitted may include: CandidateListReceipt, OptimizationRunReceipt (objective function and constraint hashes), and PolicyPackBindingReceipt.

### 9.4 Step 4—Execute Title Transfer While Preserving Usage Rights

The platform encodes a transaction execution that transfers legal title to the selected entity while preserving usage rights for the participant. In a representative embodiment, the platform generates conveyance and usage-agreement records, executes them, stores executed records, and computes a benefit-sharing parameter.

Receipts emitted may include: ConveyanceReceipt, UsageAgreementReceipt, BenefitSharingReceipt, and NotificationReceipt confirming continuity of usage.

### 9.5 Step 5—Ledger Commit, Checkpointing, and Witness Bundles

The platform inserts all receipts into the Universal Receipt Ledger using canonicalization rules, computes receipt hashes, and updates a ledger state root. At defined intervals, the platform emits checkpoint receipts binding the state root to time anchors. When a verifier requests evidence, the platform constructs witness bundles that include receipts and inclusion proofs required for stateless verification.

### 9.6 Step 6—Iteration and Lifecycle Re-Titling Without Interrupting Usage

The platform repeats the evaluate-and-optimize process on newly accumulated data, detecting when re-titling to a new entity would deliver improvements above a threshold. Re-titling is executed without interrupting participant access by maintaining usage continuity agreements, rolling over access tokens, or performing atomic cutover sequences.

### 9.7 Netting and Atomic Settlement (Optional Compression Embodiment)

In embodiments that compress transactions, the platform (i) constructs netting sets across a consented clearing group, (ii) applies setoff constraints, and (iii) executes residual settlement legs as atomic bundles across one or more rails.

A representative netting algorithm transforms obligations into a directed multigraph and uses graph algorithms or constrained optimization to select netting cycles deterministically for a given solver version and input set. A Proof-of-Netting receipt references each input obligation by receipt identifier and records the selected cycles and constraint hashes so the computation can be replayed.

A representative cross-rail atomic settlement sequence uses two-phase commit: in a prepare phase, the platform issues lock instructions to each rail; if all rails acknowledge, the platform issues commit instructions; otherwise it issues rollback instructions. Settlement manifests record external transaction identifiers for each rail and are cryptographically linked to the corresponding Proof-of-Netting receipt. Exception receipts may be emitted on failure.

### 10. EXAMPLE EMBODIMENTS AND PRODUCT-LEVEL RAILS

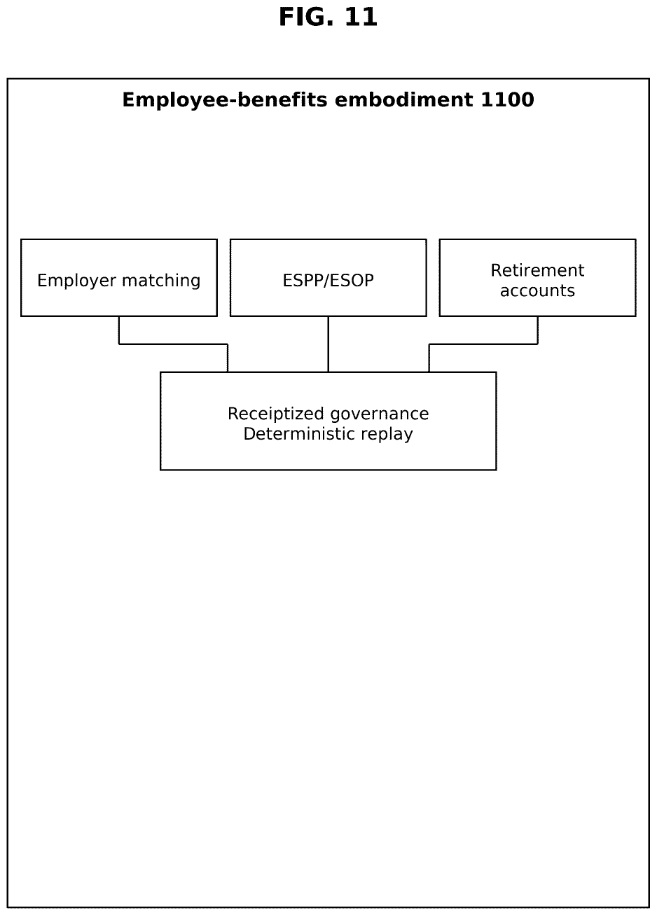

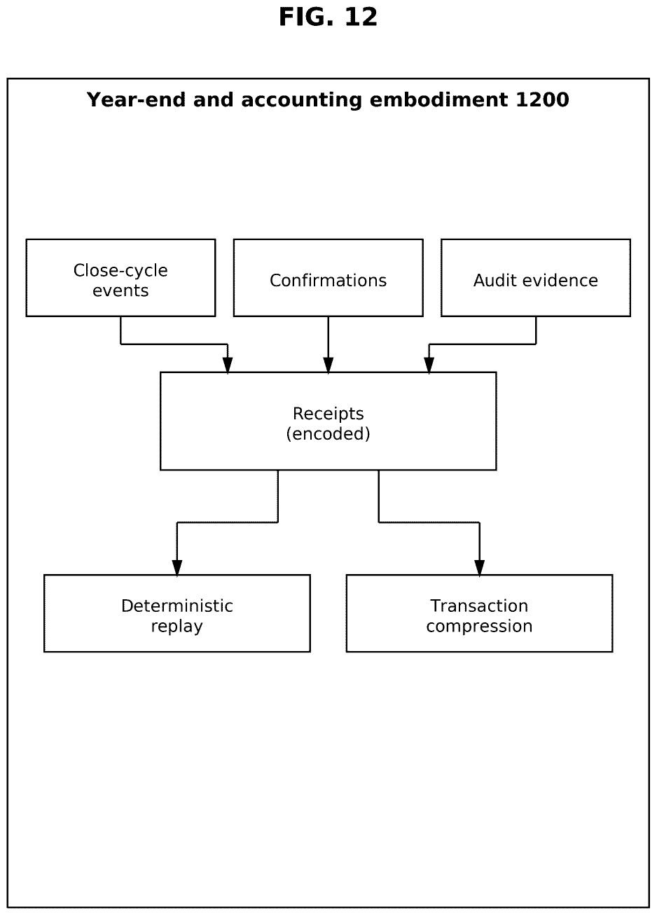

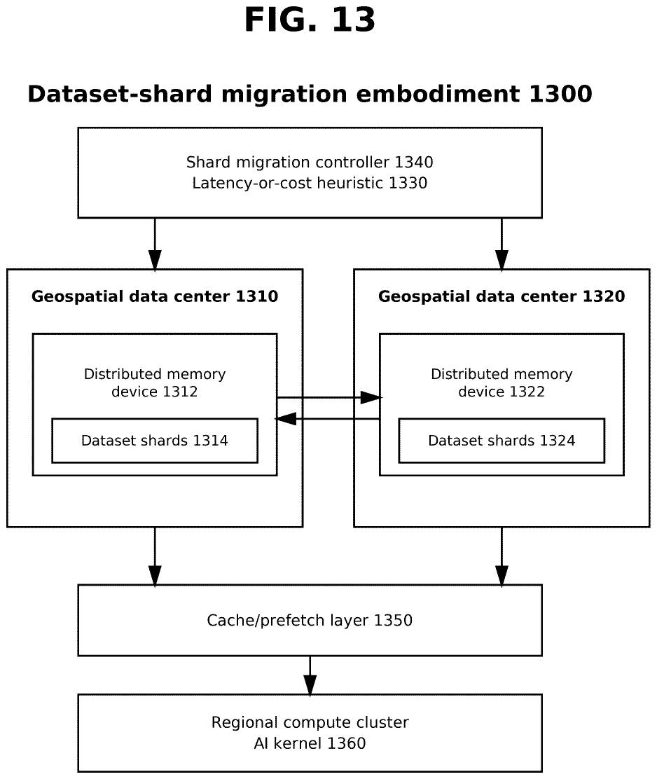

FIG. 11 illustrates an employee-benefits embodiment 1100, and FIG. 12 illustrates a year-end and accounting embodiment 1200. The embodiments described below can share the same receipt grammar, universal receipt ledger semantics, and deterministic replay mechanisms while varying domain-specific rulepacks and adapters.

The receiptized ownership-allocation kernel described herein can be applied across industries by varying domain-specific adapters, rulepacks, and receipt types, while retaining a common receipt grammar, universal receipt ledger semantics, and deterministic replay.

### 10.1 Benefits Capture (ESPP/Retirement Match)-Internalizing Point Solutions

A benefit entitlement (e.g., an employee stock purchase plan (ESPP) participation right, a qualified retirement-plan match or contribution right (e.g., a 401(k) match, IRA contribution eligibility, or pension accrual), a health savings account (HSA) contribution entitlement, or other plan-constrained entitlement) is treated as an asset-like object with constraints, even when the entitlement is non-transferable or otherwise regulated. The platform ingests plan terms and participant elections, compiles applicable rulepacks (plan rules+tax rules+jurisdiction rules), and computes a contribution/purchase vector or alternative offset vector that maximizes expected collective economic benefit while preserving compliance. The platform executes atomic bundles that may include internal advances, payroll deductions, purchases, repayments, and/or replacement contributions, and generates typed receipts (e.g., PlanTermReceipt, EligibilityReceipt, ContributionVectorReceipt, AdvanceAuthorizationReceipt, SettlementManifestReceipt) evidencing inputs, outputs, and applied policy versions.

In some embodiments, the platform does not transfer legal title of a plan-constrained entitlement (e.g., an ERISA-protected retirement-plan account or a non-assignable benefit right), but still treats the entitlement as part of the most-efficient-use optimization equation. The platform may coordinate other retitling or settlement legs (e.g., advances, offsets, substitution of cash flows, or third-party guarantees) to capture value while preserving the plan constraints; the receipt ledger records (i) that the entitlement was referenced as an input feature and constraint and (ii) that no prohibited transfer occurred.

### 10.2 Labor/Payroll (Task-Granular W-2/1099, ACA and Tax)—Policy-Lattice Gating

Work parcels (units of work) are treated as asset-like objects whose classification and compensation structure can be optimized under jurisdiction-specific rulepacks. The platform compiles rulepacks and applies them to each work parcel, emits Proof-of-Classification receipts referencing the rulepack hash and factor outcomes, and actuates payroll/benefit withholding and reporting. Household coverage and ACA affordability constraints can be treated as policy predicates, selecting safe harbors as needed.

### 10.3 Sale-Leaseback and Asset Lifecycle Re-Titling (Housing, Vehicles, Equipment)

Tangible assets (property, vehicles, equipment) are re-titled into specialized entities (SPVs, trusts, mutual pools) while preserving user usage via lease/subscription. The platform detects lifecycle triggers (life events, market rate changes, insurance costs, maintenance schedules) and re-titles assets when the predicted benefit exceeds a threshold. Recurring obligations may be netted and settled as compressed bundles.

### 10.4 Intercompany and Household Netting (Transaction Compression)

When multiple related obligations exist across entities (employers, benefit providers, household members), the platform forms netting sets that reduce gross settlement volume. A setoff policy matrix and jurisdictional constraints are evaluated before netting. The platform emits Proof-of-Netting receipts binding gross vectors, offsets, exclusions, and correlation IDs.

### 10.5 Opaque Marketplace Without the Broker (VAC/OTC+Progressive Disclosure)

Supply (latent capacity) and demand can be represented as containers with disclosure budgets. Matching is performed using predicate-only checks and selective disclosure. Identity is revealed only after commitment. Usage rights are minted and settled, and proofs of disclosure and settlement are logged as receipts.

### 10.6 Nonprofit/Philanthropic Enterprise Wrappers

Brand-or mission-linked constraints (illustrative). In some embodiments, the selected ownership entity is constrained by a nonprofit/mission wrapper, such as an entity required to route specified surplus distributions to a charitable beneficiary, community pool, or mission fund. The platform can encode such constraints as a versioned governance rulepack and bind the rulepack identifier and hash into OwnershipAllocationReceipt, SurplusReceipt, and Proof-of-Benefit receipts. Deterministic replay can then prove, for a given settlement period and configuration, that surplus was measured and distributed consistent with the rulepack, without relying on opaque intermediaries or unauditable accounting narratives.

The platform can select and govern ownership wrappers for cross-sector collaboration (nonprofit-owned for-profit structures, foundation ownership constraints) as specialized ownership entities. Governance constraints are compiled into rulepacks; compliance is proven via receipts; and measurable surplus can be routed to mission pools with enforceable audit trails.

### 10.7 Subscription-Lifecycle Orchestration (Planned Production/Consumption)

In some embodiments, usage rights are expressed as subscription-lifecycle objects whose parameters are re-optimized over time based on life events and shifting patterns. The platform can remove agent/broker layers across the lifecycle of an asset by automatically switching providers, renewing or terminating contracts, reallocating capacity, and netting the resulting obligations under receipts. The same kernel applies to insurance renewals, real estate transactions, vehicle useful-life transitions, and other lifecycle-dependent markets.

### 10.8 Accounting Close Dispersion and Time Fabric (Busy-Season Compression)

Operational workloads (close, reconciliation, audit windows) are treated as allocable resources and scheduled using a time-fabric that relabels events into multiple calendars with verifiable period anchors. The platform issues receipts proving cutoffs and enables deterministic replay of period closes to reduce disputes and smooth busy seasons.

### 11. DISINTERMEDIATION AND SECURITY-BY-COMPRESSION

The disclosure treats ‘middlemen’ broadly: broker intermediaries, agent layers, clearinghouses, manual compliance review, and even administrative transaction steps inside enterprises. The platform disintermediates by converting these functions into computable steps: AI-driven selection under constraints, policy-lattice gating, transaction compression via netting, and receipt-native auditability.

Representative mapping:

Broker/agent matching: Replaced by AI ranking of ownership entities and opaque-to-transparent matching under disclosed constraints; receipts prove selection and gates.

Clearinghouse settlement layers: Reduced via multilateral netting sets and atomic settlement bundles; fewer legs mean fewer exposure points.

Audit and reporting intermediaries: Reduced by deterministic replay and stateless witness bundles; evidence is queryable and self-verifying.

Manual compliance triage: Reduced by rulepack compilation and policy predicates; human review becomes an exception path with override receipts.

Platform rent extraction: Mitigated by internalizing advances/financing and returning surplus to participants through benefit-sharing and surplus routing.

Transaction compression also improves security. When fewer systems and handoffs are required to complete a workflow, the attack surface and opportunities for error decrease. Receipt grammar and exactly-once semantics reduce duplicate execution risks. Cryptographic anchoring and witness bundles enable verification and dispute resolution without broad data sharing.

### 12. TECHNICAL IMPROVEMENTS (COMPUTER-FUNCTIONALITY EMPHASIS)

The claimed systems provide concrete technical improvements over conventional architectures:

Reduced storage and compute footprint via quantization and specialized hardware execution for model inference/training.

Reduced recomputation and reconciliation overhead by using typed receipts, deterministic replay, and checkpointed state roots rather than unstructured logs.

Reduced transaction count and coordination latency via multilateral netting and atomic bundle execution across rails.

Improved auditability and verifiability through witness bundles enabling stateless verification and independent replay.

Deterministic replay of AI-driven allocation decisions is enabled by binding model artifacts, policy rulepacks, and normalized input/output digests into typed receipts, allowing independent verifiers to reproduce the relevant computation path (or verify it via proof receipts) without access to mutable internal databases.

Improved security by fewer handoffs, exactly-once receipt grammar, and cryptographic integrity/time anchoring.

Revocation and eligibility without intermediaries. In embodiments where usage rights, policy packs, or participant attestations must be revocable or suspendable (e.g., eligibility loss, fraud, sanctions, plan-rule changes), the platform avoids broker-style re-keying by publishing compact status receipts or status lists bound into the Universal Receipt Ledger. Usage credentials reference a revocation predicate (status_list_id +index, or status_receipt_id) so that verifiers can determine current and historical validity during deterministic replay.

Improved adaptability to changing policy and law through versioned rulepacks and policy lattice compilation with hash binding.

### 13. EXAMPLE END-TO-END SCENARIOS (ILLUSTRATIVE)

### 13.1 Scenario A—Retitle a Vehicle Into a Specialized Entity While Preserving Usage

A participant uses a vehicle primarily for commuting and occasional business use. The platform ingests usage and cost data, predicts that a specialized ownership structure would reduce total costs (insurance, tax, financing) while preserving access, and triggers a reconfiguration.

Ingest asset and participant state; log AssetIntakeReceipt and DatasetShardReceipt.

Run AI kernel to output predicted efficient-use vector; log AIDecisionReceipt and InefficiencyDeltaReceipt.

Select specialized ownership entity under constraints; log CandidateListReceipt and OptimizationRunReceipt.

Execute conveyance and usage agreement (sale-leaseback); log ConveyanceReceipt and UsageAgreementReceipt; compute benefit-sharing parameter.

Commit receipts to the ledger; emit CheckpointReceipt; notify participant of uninterrupted usage.

### 13.2 Scenario B—ESPP Cashless Participation with Internalized Advance and Receipts

A participant is eligible for an ESPP but lacks liquidity to maximize participation. The platform identifies forfeited benefit, provides an internal advance, and repays through sell-to-cover proceeds, with all legs bound by receipts for replay and audit.

Ingest plan terms and participant elections; enforce statutory and plan limits; log PlanTermReceipt and EligibilityReceipt.

Compute target contribution/purchase profile and advance amount; log BenefitOpportunityReceipt and AdvanceAuthorizationReceipt.

Execute atomic bundle: payroll deduction, stock purchase, sell-to-cover, tax withholding/remittance, repayment; log SettlementManifestReceipt and ProofOfBenefitReceipt.

Update surplus metrics (fees avoided vs external lender) and route surplus per governance; log SurplusReceipt.

### 13.3 Scenario C-Household Netting of Payroll, Premiums, and Taxes with Setoff Constraints

A household participates in multiple employer and benefit-provider systems. The platform forms a consented clearing group, predicts near-term obligation streams, forms netting sets, and settles only residuals.

Collect obligations and constraint packs (policy+setoff legality); log ObligationIntakeReceipts and PolicyPackBindingReceipt.

Compute candidate netting cycles; apply setoff mask; log ProofOfNettingReceipt including exclusions and no-net reasons.

Execute residual settlement legs atomically across rails with correlation IDs; log SettlementManifestReceipt and any RollbackReceipts on failure.

Construct witness bundle for auditor/regulator verification; log WitnessBundleReceipt.

### 14. ALTERNATIVE EMBODIMENTS AND IMPLEMENTATION VARIATIONS

Additional security embodiments can include: (i) encryption of receipt payloads at rest and in transit with per-tenant keys; (ii) hardware-backed key storage; (iii) trusted execution environments (TEEs) or secure enclaves to protect model artifacts, policy rulepacks, and receipt-signing keys; and (iv) remote attestation receipts that bind a receipt to a measured software/hardware configuration.

For controlled redaction, some implementations use redactable signatures or a chameleon-hash construction such that selected fields may be removed or replaced under governance while preserving verifiability of remaining fields. In such embodiments, a redaction action itself is logged as a typed receipt linked to the prior unredacted receipt (or to a witness object) and authorized under a policy rulepack.

To support privacy-preserving verification, some implementations generate proof receipts that include or reference: Merkle inclusion proofs, vector-commitment proofs, range proofs, or zero-knowledge proofs that attest to satisfaction of a predicate (e.g., policy compliance or threshold satisfaction) without revealing underlying sensitive values.

The disclosed techniques can be implemented in many configurations without departing from the spirit of the invention.

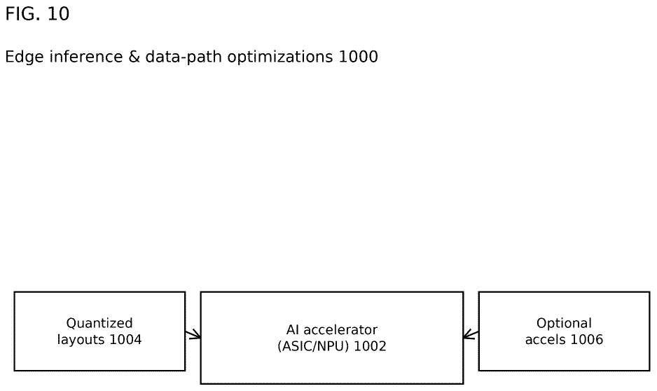

Hardware: ASIC acceleration is optional; GPU/TPU or CPU implementations may be used. Quantization may be static or dynamic, and continual-learning may be performed centrally or at the edge. As shown in FIG. 10, an example AI acceleration hardware embodiment 1000 can include an AI accelerator (e.g., ASIC/NPU) 1002 operating on quantized memory layouts 1004, with optional hardware accelerators 1006.

Ledgers: The Universal Receipt Ledger may be implemented as an internal Merkle-DAG event store, a permissioned ledger, or a hybrid with periodic anchoring to an external timestamping service or public chain.

In some embodiments, the Universal Receipt Ledger is implemented as an append-only Merkle-tree log that provides both inclusion proofs and consistency proofs, so a verifier can confirm that a later published root is an append-only extension of an earlier root. To scale proofs and distribution, the ledger may publish tiled or sharded Merkle subtrees (e.g., per time window or per tenant), and ReplayManifestReceipt objects may reference tile identifiers rather than enumerating all receipt IDs.

In embodiments that expose inclusion and consistency proofs to external verifiers, the Universal Receipt Ledger may be implemented as a transparency log. For example, a Merkle-tree-based append-only log may publish signed tree heads (checkpoint roots) and provide verifiable consistency proofs between successive tree heads so that a verifier can detect equivocation or retroactive modification. Transparency-log constructions similar to certificate transparency (e.g., RFC 6962) may be used as a building block, while still recording the disclosed typed receipts that bind the ownership-allocation kernel to model and policy provenance.

For variable-size receipts or bulky evidence, the ledger may decouple indexing from payload storage by storing receipt payloads in a write-once append-only value store and storing only fixed-size hashes, offsets, or pointers in the Merkle structure, thereby enabling efficient verification while avoiding rewriting large blobs. Witness bundles may include the minimal payload segments required for replay.

Privacy: Receipts can be stored with encrypted payloads and public digests, supporting selective disclosure and controlled redaction under governance.

Status and revocation: In some embodiments, credential validity and eligibility are published as compressed status lists (e.g., bitmaps) that are themselves committed into the receipt ledger via StatusListReceipt objects, so that replay and verification can be performed offline against historical status snapshots without querying external issuers.

Retention: In some embodiments, retention windows and deletion/redaction operations are themselves receiptized. A RetentionReceipt may record policy basis, scope, and time window for retaining or deleting categories of witness objects and receipt fields, and a verifier can confirm that redactions were policy-authorized while still replaying integrity commitments over remaining fields.

Settlement: Some implementations use only traditional rails; others use programmable rails; atomicity may be provided by two-phase commit, escrow, or other distributed transaction protocols.

Policy: Rulepacks may be compiled from curated sources, machine-readable feeds, or a combination with human validation; the lattice may include jurisdiction precedence graphs and time validity windows.

What is claimed is:

1. A system for allocating asset ownership for maximized collective economic benefit, the system comprising:
at least one computer system comprising a processor and a memory storing executable instructions, wherein the processor executes the instructions to:
receive information about a user and an asset used or to be used by the user;
store neural-network weights as a 32-bit floating-point variable;
store neural-network activations as a 32-bit floating-point variable;
statically quantize neural-network weights and neural-network activations as 8-bit integers,
wherein the neural-network weights are quantized to reduce storage footprint;
ingest asset utilization transaction data containing historical sale, lease, usage and user profile records for the user asset pair; and
retrieve supplemental historical datasets of economic outcomes and user demographics;
utilize an application-specific integrated circuit (ASIC) for an artificial neural network connected to the memory, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein at least one hidden input intermediate layer(s) contains a plurality of neurons, each performing weighted calculations to identify patterns, correlations, and relationships within the input data, wherein the hidden layer(s) uses activation functions comprising ReLU (Rectified Linear Unit) and sigmoid functions to determine non-linear relationships; a plurality of synaptic circuits, each synaptic circuit storing a synaptic weight and coupling at least two neurons; and circuitry operable to execute a functionally invariant path (FIP) algorithm that updates network weights along differential geometry paths so as to preserve learned behavior while increasing sparsity wherein the array is configured to analyze said business sale transaction information, asset usage, ownership structures, and economic outcomes, trained on historical datasets including a parameter for each of business sale transaction information, asset usage, ownership structures, and economic outcomes, wherein the AI/ML categorization engine makes a prediction regarding the most efficient use(s) of an asset;
wherein during the training process the ASIC uses supervised learning, where labeled datasets containing known inputs and desired outputs are fed into the network; the neural network adjusts its internal weights using a backpropagation algorithm, which minimizes the difference between the network's predictions and the actual outcomes as measured by a mean squared error loss function and the ASIC iteratively refines its predictions until the error rate falls below a predefined threshold, ensuring that the network can make accurate predictions on new, unseen data;
wherein the ASIC is further configured to:
execute a artificial intelligence machine learning categorization engine on the asset utilization transaction data and output a predicted most efficient use vector for the asset;
compare the ASIC output to the user's declared or observed usage pattern and flag in the data structure a projected differential meeting or exceeding a predefined threshold ownership inefficiency;
issue a query to an ownership entity database and return a ranked candidate list of specialized entities;
compute the maximum function output value of expected collective economic benefit across the candidate list and select the top ranked entity;
encode a parameter for a transaction execution that transfers legal title to the selected entity while preserving usage rights for the user, wherein encoding the transfer and preservation of usage rights comprises: generating, in memory, a conveyance record designating the selected ownership entity as owner of the asset and a usage agreement record granting the user possession or access under a lease, rental, or long term usage agreement; executing the conveyance and usage agreement; storing the executed records in a database of assets, ownership entities, and users; and calculating and storing a benefit sharing parameter to be redistributed to the user; and wherein the memory further stores instructions that cause the system to:
migrate dataset shards between distributed memory devices in different geospatial data centers whenever a latency or cost heuristic is met to sustain parallel low latency access, wherein migrating dataset shards between geospatial data centers comprises caching frequently accessed data and prefetching anticipated data to reduce access latency;
repeat, using the ASIC, an evaluate and optimize process to detect that retitling of an asset would deliver an improvement above a set threshold and invoke another title transfer routine that assigns the asset to a newly selected entity without interrupting user access;
apply the FIP algorithm to newly accumulated asset utilization transaction data so as to refine prediction accuracy while preserving prior knowledge; and
dispatch an electronic alert to the user confirming continuity of usage following an ownership reassignment.

2. The system of claim 1, further comprising:
a universal receipt ledger configured as an append-only data store;
a receipt engine configured to: generate, for at least (i) execution of the categorization engine, (ii) selection of the top-ranked entity, and (iii) the ownership reassignment that transfers legal title while preserving usage rights, a plurality of typed receipts that conform to a canonical receipt format defining at least: a receipt identifier, a receipt type, a timestamp, an input digest computed over normalized inputs to a corresponding step, an output digest computed over outputs of the corresponding step, a model identifier identifying a model artifact used by the categorization engine, a policy identifier identifying a versioned policy or rulepack applied as a constraint, and a digital signature verifiable as produced by an authorized subsystem; and append the plurality of typed receipts to the universal receipt ledger; and a deterministic replay engine configured to, using at least a checkpoint receipt that commits to a cryptographic root over at least a subset of the typed receipts and an ordered subset of the typed receipts from the universal receipt ledger, deterministically reproduce at least (a) the selection of the top-ranked entity and (b) the ownership reassignment that transfers legal title while preserving usage rights, and to verify integrity of the reproduction by comparing a recomputed digest to a digest stored in at least one of the typed receipts, wherein computing the maximum function output value of expected collective economic benefit across the candidate list is performed subject to one or more constraints defined by the versioned policy or rulepack identified by the policy identifier.

3. The system of claim 2, wherein each typed receipt is serialized using a deterministic canonicalization procedure and includes a link value comprising a cryptographic hash pointer to at least one prior typed receipt, whereby the typed receipts form a hash-linked sequence and wherein the receipt identifier comprises a cryptographic hash over at least the receipt type, the timestamp, the input digest, the output digest, and the link value, such that the universal receipt ledger is content-addressable.

4. The system of claim 2, wherein at least a subset of the typed receipts include (i) a pre-receipt state root and (ii) a post-receipt state root, and wherein the deterministic replay engine verifies the integrity by recomputing the post-receipt state root from the pre-receipt state root and a corresponding receipt payload.

5. The system of claim 2, wherein the universal receipt ledger stores at least some receipt evidence as content-addressed witness objects referenced by hash from the typed receipts, thereby compressing the universal receipt ledger by deduplicating shared witness objects across multiple typed receipts.

6. The system of claim 2, wherein the receipt engine periodically generates a checkpoint receipt that commits to a Merkle root or vector-commitment root over a batch of typed receipts appended during a time window, digitally signs the checkpoint receipt, and generates a replay-manifest receipt that references the checkpoint receipt and enumerates an ordered subset of the typed receipts for bounded deterministic replay.

7. The system of claim 6, further comprising an anchoring interface configured to publish the Merkle root or vector-commitment root to an external tamper-evident log or distributed ledger, thereby enabling third-party verification of inclusion of a typed receipt using an inclusion proof.

8. The system of claim 2, wherein a receipt grammar defines a uniqueness constraint keyed by an idempotency key such that, for a given idempotency key, the receipt engine stores at most one corresponding typed receipt, thereby preventing duplicate posting.

9. The system of claim 2, wherein preserving continuity of usage comprises issuing to the user a usage credential or access token that grants a non-transferable right to use the asset while legal title is held by the selected specialized ownership entity, the usage credential or access token specifying at least one of an expiration, a usage window, an access tier, or a revocation predicate, wherein the revocation predicate references a status receipt or status list committed in the universal receipt ledger.

10. The system of claim 2, further comprising a settlement engine configured to minimize a number of settlement legs for the reassignment of ownership by netting at least a subset of obligations subject to setoff-right constraints, and to generate and append to the universal receipt ledger a proof-of-netting receipt that enumerates gross obligations, applied offsets, exclusions, residuals, and one or more settlement correlation identifiers.

11. A computer-implemented method for receiptized allocation of ownership of an asset, the method comprising:
receiving, by at least one processor, information identifying (i) a user and (ii) an asset used or to be used by the user; ingesting asset-utilization transaction data containing historical sale, lease, usage, and user-profile records for a user-asset pair and retrieving one or more supplemental historical datasets of economic outcomes and user demographics; executing, using an application-specific integrated circuit (ASIC) neural-network hardware accelerator, an artificial-intelligence/machine-learning categorization engine to output a predicted most-efficient-use vector for the asset, wherein executing the categorization engine comprises: storing neural-network weights as a 32-bit floating-point variable; storing neural-network activations as a 32-bit floating-point variable; and statically quantizing the neural-network weights and the neural-network activations as 8-bit integers, wherein the neural-network weights are quantized to reduce storage footprint; comparing the predicted most-efficient-use vector to a declared or observed usage configuration for the user-asset pair to determine an ownership-inefficiency measure meeting or exceeding a predefined threshold; querying an ownership-entity database storing a plurality of specialized ownership entities, returning a ranked candidate list, and selecting a specialized ownership entity that maximizes an objective function representing expected collective economic benefit subject to one or more constraints defined by a versioned policy or rulepack; executing a reassignment of ownership by transferring legal title for the asset to the selected specialized ownership entity while preserving, for the user, continuity of usage of the asset under a usage-rights record, wherein executing the reassignment of ownership comprises: generating a conveyance record designating the selected specialized ownership entity as owner of the asset and a usage-agreement record granting the user possession or access under a lease, rental, subscription, or long-term usage agreement;
executing the conveyance record and the usage-agreement record; storing executed records in a database of assets, ownership entities, and users; and calculating and storing a benefit-sharing parameter configured to redistribute to the user at least a portion of incremental economic benefit associated with the reassignment of ownership; generating a plurality of typed receipts conforming to a canonical receipt format, the typed receipts including at least a receipt identifier, a receipt type, a timestamp, an input digest, an output digest, a model identifier, a policy identifier, and a digital signature; appending the plurality of typed receipts to a universal receipt ledger configured as an append-only data store; and performing deterministic replay, using at least a checkpoint receipt that commits to a cryptographic root over at least a subset of the typed receipts and an ordered subset of the typed receipts from the universal receipt ledger, to reproduce at least the selecting and the executing of the reassignment of ownership and to verify integrity by comparing a recomputed digest to a digest stored in at least one of the typed receipts.

12. The method of claim 11, wherein executing the categorization engine comprises utilizing an application-specific integrated circuit (ASIC) for an artificial neural network connected to memory, the ASIC comprising:
a plurality of neurons organized in an array, wherein each neuron comprises a register, a processing element, and at least one input; a plurality of synaptic circuits, each synaptic circuit including a memory for storing a synaptic weight, wherein each neuron is connected to at least one other neuron via one of the plurality of synaptic circuits; at least one hidden input intermediate layer containing a plurality of neurons each performing weighted calculations to identify patterns, correlations, and relationships within input data, wherein the at least one hidden layer uses activation functions comprising rectified linear unit (ReLU) and sigmoid functions to determine non-linear relationships; and circuitry operable to execute a functionally invariant path (FIP) algorithm that updates network weights along differential-geometry paths so as to preserve learned behavior while increasing sparsity; wherein during a training process the ASIC uses supervised learning in which labeled datasets containing known inputs and desired outputs are fed into the artificial neural network, the artificial neural network adjusts internal weights using a backpropagation algorithm that minimizes a difference between network predictions and actual outcomes as measured by a mean squared error loss function, and the ASIC iteratively refines predictions until an error rate falls below a predefined threshold.

13. The method of claim 11, further comprising migrating dataset shards between distributed memory devices in different geospatial data centers whenever a latency-or-cost heuristic is met and prefetching anticipated data to reduce access latency for subsequent executions of the categorization engine, wherein migrating dataset shards comprises caching frequently accessed data.

14. The method of claim 11, further comprising refining prediction accuracy while preserving prior learned behavior by updating model parameters along a sparsity-preserving path represented by a functionally invariant path (FIP) algorithm.

15. The method of claim 11, further comprising gating at least one action selected from (i) the reassignment of ownership and (ii) the netting of obligations, by evaluating predicates of a versioned policy rulepack, and recording in at least one typed receipt a rulepack identifier and a hash of the versioned policy rulepack used.

16. The method of claim 11, wherein the asset comprises a unit of work or work-related entitlement, and further comprising generating and appending to the universal receipt ledger a proof-of-classification receipt that records at least a jurisdiction identifier, factor outcomes, and a classification result that configures whether the unit of work is processed under an employee (W-2) posture or an independent-contractor (1099) posture.

17. The method of claim 11, wherein the asset comprises a plan-constrained entitlement, the plan-constrained entitlement being selected from: (i) an employee stock purchase plan participation right; (ii) a qualified retirement plan contribution and/or employer-match entitlement; (iii) a health savings account contribution entitlement; (iv) a health coverage premium subsidy and/or premium tax credit eligibility determined under an applicable health coverage policy; and (v) an insurance policy right, and wherein encoding and executing the transaction-execution parameter comprises executing an atomic bundle that includes at least one of: an internal advance, a payroll deduction, a contribution, a premium payment, a purchase, a repayment, or a settlement offset, while generating and appending to the universal receipt ledger at least a PlanTermReceipt, an EligibilityReceipt, and a SettlementManifestReceipt.

18. A non-transitory computer-readable medium storing instructions that, when executed by at least one processor of a computing system, cause the computing system to perform operations comprising:
receiving information identifying a user and an asset used or to be used by the user;
ingesting asset-utilization transaction data containing historical sale, lease, usage, and user-profile records for a user-asset pair and retrieving one or more supplemental historical datasets of economic outcomes and user demographics;
executing, using an application-specific integrated circuit (ASIC) neural-network hardware accelerator, an artificial-intelligence/machine-learning categorization engine on the asset-utilization transaction data and the one or more supplemental historical datasets to output a predicted most-efficient-use vector for the asset, wherein executing the categorization engine comprises:
storing neural-network weights as a 32-bit floating-point variable;
storing neural-network activations as a 32-bit floating-point variable; and
statically quantizing the neural-network weights and the neural-network activations as 8-bit integers, wherein the neural-network weights are quantized to reduce storage footprint;
comparing the predicted most-efficient-use vector to a declared or observed usage configuration for the user-asset pair to determine an ownership-inefficiency measure meeting or exceeding a predefined threshold;
querying an ownership-entity database storing a plurality of specialized ownership entities, returning a ranked candidate list, and selecting a specialized ownership entity that maximizes an objective function representing expected collective economic benefit subject to one or more constraints defined by a versioned policy or rulepack;
executing a reassignment of ownership that transfers legal title for the asset to the selected specialized ownership entity while preserving continuity of usage for the user, wherein executing the reassignment of ownership comprises generating a conveyance record and a usage-agreement record, executing the conveyance record and the usage-agreement record, storing executed records, and determining a benefit-sharing parameter;
migrating dataset shards between distributed memory devices in different geospatial data centers whenever a latency-or-cost heuristic is met to sustain parallel low-latency access, wherein migrating dataset shards comprises caching frequently accessed data and prefetching anticipated data to reduce access latency;
repeating, using the ASIC, an evaluate-and-optimize process on newly accumulated asset-utilization transaction data to detect that re-titling of the asset would deliver an improvement above a set threshold and invoking another title-transfer routine that assigns the asset to a newly selected specialized ownership entity without interrupting user access;
applying a functionally invariant path (FIP) algorithm to newly accumulated asset-utilization transaction data so as to refine prediction accuracy while preserving prior learned behavior;
dispatching an electronic alert to the user confirming continuity of usage following an ownership reassignment;
generating typed receipts conforming to a canonical receipt format and appending the typed receipts to an append-only universal receipt ledger; and
enabling deterministic replay of at least the selecting and the executing of the reassignment of ownership from the typed receipts stored in the universal receipt ledger.

19. The non-transitory computer-readable medium of claim 18, wherein the operations further comprise forming, for a settlement period, a netting set across a plurality of obligations associated with the reassignment of ownership, enforcing setoff-right constraints, executing residual settlement legs across one or more payment rails using settlement correlation identifiers, and generating a proof-of-netting receipt appended to the universal receipt ledger.

20. The non-transitory computer-readable medium of claim 19, wherein the operations further comprise:
computing, from at least one proof-of-netting receipt stored in the universal receipt ledger, a surplus value representing a reduction in at least one of (i) gross settlement value or (ii) gross transaction count relative to a baseline;
appending to the universal receipt ledger a surplus receipt that includes the surplus value and links the surplus value to one or more source receipts and to a distribution-rules identifier;
distributing at least a portion of the surplus value as at least one of (i) the benefit-sharing parameter or (ii) a negative-fee credit; and
providing to a verifier device an evidence bundle comprising at least the surplus receipt and a checkpoint receipt to enable verification of integrity of the surplus receipt via deterministic replay.
